(19) United States
(12) Patent Application Publication
(10) Pub. No.: US 2008/0218958 A1
(43) Pub. Date: Sep. 11, 2008

(54) COMPUTER ENCLOSURE WITH DRIVE BRACKET

(75) Inventors: YUN-LUNG CHEN, Tu-Cheng (TW); QING-HAO WU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/778,091

(22) Filed: Jul. 16, 2007

(30) Foreign Application Priority Data
Mar. 6, 2007 (CN) 200720200121.6

(51) Int. Cl. G06F 1/16

(52) U.S. Cl. 361/684

(57) ABSTRACT

A computer enclosure includes a chassis with a supporter attached therein and a drive bracket assembly with a sliding member formed thereon. The supporter has an arced surface. A plurality of parallel ridges are protruded from the arced surface and arranged along the arced surface. The drive bracket assembly is mounted on the chassis, and configured to rotate on the chassis between a securing position where the drive bracket assembly is horizontally located on the supporter and different inclined positions where a corresponding ridge of the plurality of ridges blocks the sliding member to prevent the sliding member sliding freely by gravity.

### BACKGROUND

1. Field of the Invention

The present invention relates to computer enclosures, and more particularly to a computer enclosure with a drive bracket pivotally connected to the computer enclosure.

2. Description of Related Art

Various data storage devices, such as hard disk drives, floppy disk drives, and optical drives are installed in drive brackets, which are located above a motherboard in a computer enclosure. Usually a typical drive bracket is directly secured in the computer enclosure with a plurality of screws. However, a space in the computer enclosure is limited particularly for some mini personal computers. It is hard to maintain the motherboard in these computer enclosures, such as inserting or removing some extending cards on the motherboard below the drive bracket.

Therefore, pivotable drive brackets have been developed. A conventional compute enclosure has two pivotable drive brackets. A mounting panel is secured in the computer enclosure. The mounting panel extends at least one locating tab. The two drive brackets are pivotally attached to the mounting panel on two sides thereof respectively. Each of the two drive brackets integrally extends a supporting leg at one side thereof, and forms a flange at the other side thereof. The flanges of the two drive brackets are rotatably connected with the locating tab by connecting shafts. The supporting legs function as supports when any of the drive brackets is rotated to a position parallel to the other one. Each of the drive brackets can be pivoted to a folded position upon the other one. In the above computer enclosure, when a drive bracket is rotated, another drive bracket is needed to support the rotated drive bracket. However, in some computer enclosures, only one drive bracket is provided. It is impossible for the only one drive bracket to rotate and be supported in the above manner.

### SUMMARY

A computer enclosure includes a chassis with a supporter attached therein and a drive bracket assembly with a sliding member formed thereon. The supporter has an arced surface. A plurality of parallel ridges are protruded from the arced surface and arranged along the arced surface. The drive bracket assembly is mounted on the chassis, and configured to rotate on the chassis between a securing position where the drive bracket assembly is horizontally located on the supporter and different inclined positions where a corresponding ridge of the plurality of ridges blocks the sliding member to prevent the sliding member sliding freely by gravity.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is an exploded, isometric view of a computer enclosure in accordance with a preferred embodiment of the present invention, comprising a chassis, a drive bracket, and a supporter, wherein part of the chassis is cut away;

FIG. 2 is an assembled view of FIG. 1, showing the drive bracket being generally vertically positioned, wherein part of the chassis is cut away;

FIG. 3 is an assembled view of FIG. 1, showing the drive bracket in an inclined position, wherein part of the chassis is cut away; and

FIG. 4 is an assembled view of FIG. 1, showing the drive bracket in a generally horizontally position, wherein part of the chassis is cut away.

### DETAILED DESCRIPTION OF THE EMBODIMENT

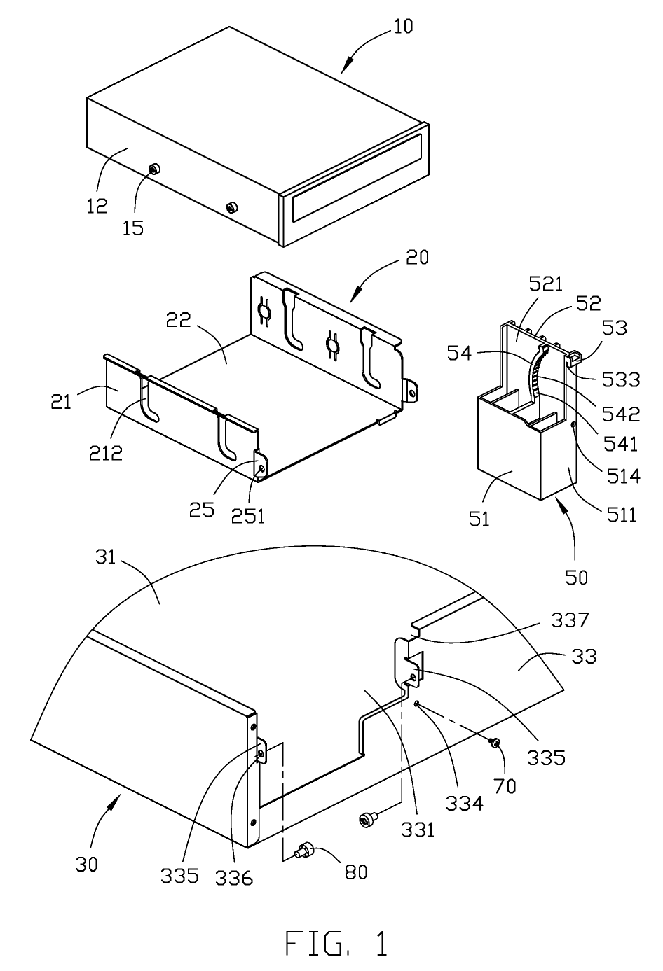

Referring to FIG. 1, a computer enclosure in accordance with a preferred embodiment of the present invention includes a chassis 30, a drive bracket 20 for mounting a data storage device 10 therein, and a supporter 50.

The chassis 30 includes a bottom plate 31 for mounting a motherboard thereon (not shown), and a front plate 33 formed upwardly from a front edge of the bottom plate 31. The front plate 33 defines an opening 331 therein for exposing the data storage device 10 outside the chassis 30 when the data storage device 10 is mounted in the chassis 30. The front plate 33 forms two pieces 335 beside two sides of the opening 331 respectively. Each piece 335 defines a hole 336. A securing hole 334 is defined in the front plate 33 below one of the pieces 335. The front panel 33 defines a cutout 337 at an upper edge thereof above the securing hole 334.

The data storage device 10 includes a pair of side walls 12. Each side wall 12 forms a pair of sliding members 15.

The drive bracket 20 includes a bottom 22 and a pair of side pieces 21 extending upwardly from opposite side edges of the bottom 22. The bottom 22 and the pair of side pieces 21 together define a receiving space thereamong for accommodating the data storage device 10 therein. Each side piece 21 defines a pair of L-shaped sliding slots 212 corresponding to the sliding members 15 of the data storage device 10. Each side piece 21 extends forwards to form a tab 25 thereof. Each tab 25 defines a hole 251 corresponding to the hole 336 of chassis 30.

The supporter 50 includes a base 51 which has a front face 511 parallel to the front plate 33. A hole 514 is defined in the front face 511 corresponding to the securing hole 334 of the front plate 33. One side of the base 51 that is far away from the opening 331 extends upwardly to form a side plate 52 thereof. An arc-shaped rib 54 is protruded from a side of the side plate 52 towards the opening 331. The rib 54 has an inner arced surface 541 with a plurality of parallel elastic ridges 542 formed thereon. The ridges 542 are equidistantly spaced apart on the inner arced surface 541, and extend in a horizontal direction. The side plate 52 forms a block 53 on a front portion thereof corresponding to the cutout 337 in the front plate 33. A gap 533 is defined between the block 53 and the front face 511 of the supporter 50.

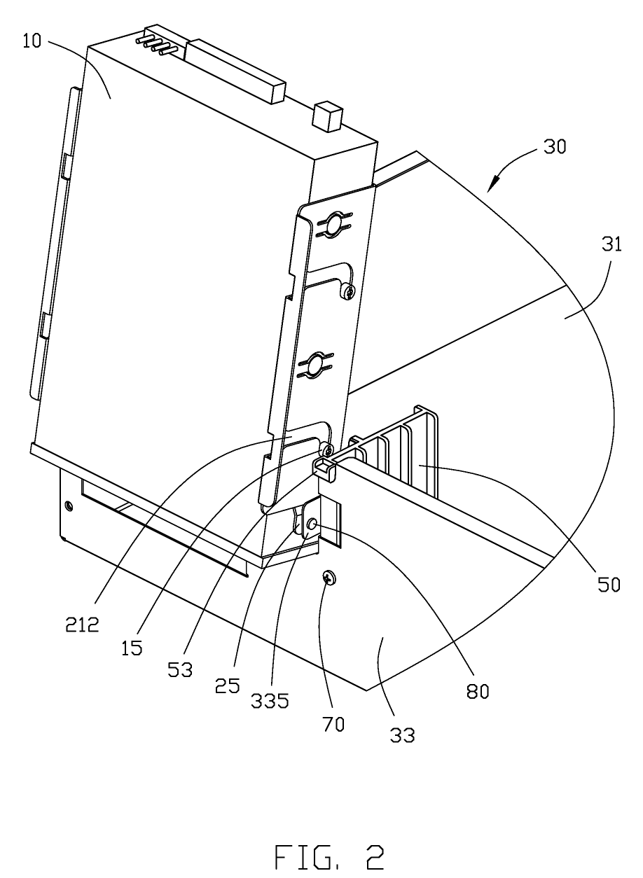

Referring to FIG. 2, in assembly, the supporter 50 is placed in the chassis 30. The block 53 of the supporter 50 is received in the cutout 337, and the upper edge of the front plate 33 in the cutout 337 is inserted in the gap 533. Simultaneously, the hole 514 of the supporter 50 is aligned with the securing hole 334 of the front plate 33. A screw 70 is inserted into the hole 514 and the securing hole 334 to secure the supporter 50 in the chassis 30. At this moment, a center of curvature of the arced surface 541 is located on a line defined by the two holes 336 of the front plate 33.

The data storage device 10 is placed in the drive bracket 20 with the sliding members 15 of the data storage device 10 sliding into the slots 212 of the drive bracket 20 to form a drive bracket assembly. The sliding members 15 extend through the slots 212 of the side pieces 21, and are exposed outside of the drive bracket 20.

Then, the drive bracket 20 with the data storage device 10 is generally vertically positioned with a rear end of the drive bracket 20 tilted upwards. The two holes 251 of the drive bracket 20 are aligned with the two holes 336 of the front plate 33. Two pivoting pins 80 insert into the aligned holes 251 and 336 to pivotally secure the drive bracket 20 to the front plate 33 of the chassis 30. The line defined by the two holes 336 of the front plate 33 serves as a pivoting axis of the drive bracket 20. A distance between the arced surface 541 and the center of curvature of the arced surface 541 is equal to a distance between one sliding member 15 and the pivoting axis. When the drive bracket 20 rotates about the pivoting axis, a moving trace of the sliding member 15 of the data storage device 10 is located on the arced surface 541 of the rib 54.

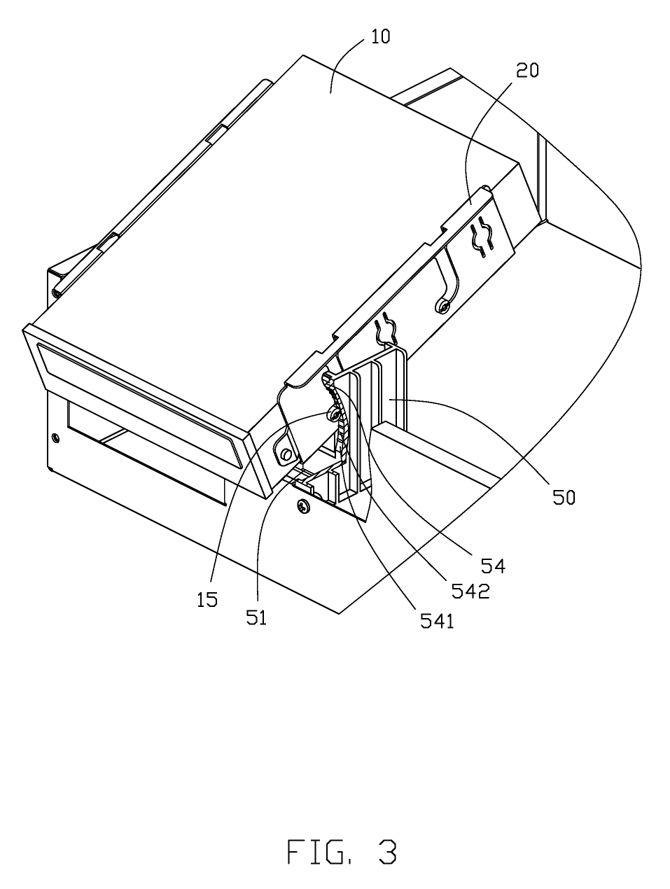

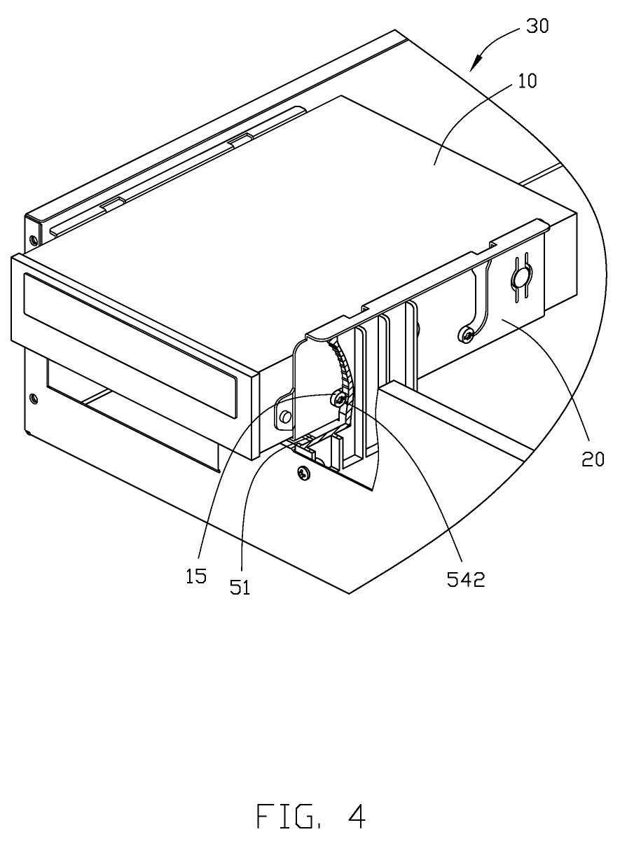

Referring to FIGS. 3 and 4, the drive bracket 20 rotates downwardly. The sliding member 15 slides along the arced surface 541, and elastically presses the elastic ridges 542. Simultaneously, the arced surface 541 resists against the sliding member 15 to prevent the data storage device 10 sliding in the drive bracket 20. The drive bracket 20 rotates until the drive bracket 20 is located on the base 51 to mount the drive bracket 20 in a securing position.

When the motherboard below the drive bracket 20 needs to be maintained, the drive bracket 20 is rotated upwardly to an inclined position. In the inclined position, the sliding member 15 is blocked by an elastic ridge 542. When the inclined position is needed to be changed, an outside force is applied to the drive bracket 20 to rotate the drive bracket 20. The outside force drives the sliding member 15 sliding over the ridge 542 by overcoming the elastic force of the current ridge 542.

In the above embodiment, the ridges 542 on the arced surface 541 can be omitted, instead the rib 54 can be widened to have the distance between the arced surface 541 and the center of curvature of the arced surface 541 being slightly smaller than the distance between the sliding member 15 and the pivoting axis, so the drive bracket 20 can be held in an inclined position by the sliding member 15 elastically extruding the arced surface 541 to create breakout friction between the arced surface 541 and the sliding member 15 to prevent the sliding member 15 sliding freely.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A computer enclosure, comprising:
a chassis with a supporter attached therein, the supporter having an arced surface, a plurality of parallel ridges protruded from the arced surface and arranged along the arced surface; and
a drive bracket assembly with a sliding member formed thereon, the drive bracket assembly mounted on the chassis, and configured to rotate on the chassis between a securing position where the drive bracket assembly is horizontally located on the supporter and different inclined positions where a corresponding ridge of the plurality of ridges blocks the sliding member to prevent the sliding member sliding freely by gravity.

2. The computer enclosure as described in claim 1, wherein the drive bracket assembly is rotatable relative to the chassis about a pivoting axis on which a center of curvature of the arced surface is located.

3. The computer enclosure as described in claim 2, wherein a distance between the arced surface and the center of curvature of the arced surface is equal to a distance between the sliding member and the pivoting axis.

4. The computer enclosure as described in claim 2, wherein the plurality of ridges is equidistantly spaced on the arced surface, and extends along a direction of the pivoting axis.

5. The computer enclosure as described in claim 1, wherein the supporter comprises a side plate with an arc-shaped rib protruding towards the drive bracket assembly, and an inner surface of the arc-shaped rib forms the arced surface with the plurality of ridges provided thereon.

6. The computer enclosure as described in claim 5, wherein a block is formed on a front portion of the side plate, and the chassis comprises a front plate with a cutout defined on a top edge thereof receiving the block therein.

7. The computer enclosure as described in claim 6, wherein a gap is defined between the block and the side plate receiving the edge of the front plate therein.

8. The computer enclosure as described in claim 5, wherein the supporter comprises a base located below the side plate to support the drive bracket assembly when the drive bracket assembly is in the securing position.

9. A computer enclosure, comprising:
a chassis having an arced surface formed thereon; and
a drive bracket assembly with a sliding member formed thereon, the drive bracket assembly pivotally mounted on the chassis around an pivoting axis on which a center of curvature of the arced surface is located, a distance between the arced surface and the center of curvature of the arced surface being slightly smaller than a distance between the sliding member and the pivoting axis, the drive bracket assembly being able to be held in an inclined position by the sliding member elastically pressing the arced surface to create a friction force between the arced surface and the sliding member to prevent the sliding member sliding freely.

10. The computer enclosure as described in claim 9, wherein the chassis comprises a supporter secured therein, the support comprising a base on which the drive bracket assembly is located when the drive bracket assembly is in a secured position.

11. The computer enclosure as described in claim 10, wherein the support comprises a side plate formed above the base, the side plate protrudes an arc-shaped rib towards the drive bracket assembly, and the inner surface of the rib forms the arced surface.

12. The computer enclosure as described in claim 11, wherein a block is formed on a front portion of the side plate, the chassis comprises a front plate with a cutout defined on a top edge thereof receiving the block therein.

13. The computer enclosure as described in claim 12, wherein a gap is defined between the block and the side plate configured for the edge of the front plate inserted into.

14. The computer enclosure as described in claim 9, wherein at least one ridge is formed on the arced surface configured for blocking the sliding member sliding downwards by gravity when the drive bracket assembly is in the inclined position.

15. The computer enclosure as described in claim 14, wherein a plurality of ridges is formed on the arced surface for providing different inclined positions on the arced surface, the plurality of ridges are equidistantly spaced on the arced surface, and extends along a direction of the pivoting axis.

16. A computer, comprising:
a chassis;
a supporter mounted in the chassis, the supporter having a curved surface formed thereon;
a drive bracket rotatably mounted on the chassis relative to a pivoting axis between a first position where the drive bracket is horizontally supported on the supporter and a second position where the drive bracket is obliquely oriented and is moved away from the supporter; and
a data storage device having a sliding protrusion, the data storage device being received in the drive bracket with the sliding protrusion thereof abutting against and being slidable on the curved surface of the supporter.

17. The computer as described in claim 16, wherein the curved surface is structured and arranged in a manner such that a friction force generated between the sliding protrusion of the data storage device and the curved surface of the supporter is sufficient to overcome gravity acting on the data storage device.

18. The computer as described in claim 16, wherein a plurality of ridges is formed on the curved surface of the supporter for blocking the sliding protrusion sliding downwards by gravity when the drive bracket is in the second position.
